(19) United States
(12) Patent Application Publication
(10) Pub. No.: US 2003/0025275 A1
(43) Pub. Date: Feb. 6, 2003

(54) Mechanical face seal designs for small shafts

(76) Inventor: Timothy F. Miller, Thornton, CO (US)

Correspondence Address: RANDALL J. KNUTH P.C., 3510-A STELLHORN ROAD, FORT WAYNE, IN, 46815-4631, US

(21) Appl. No.: 10/207,293

(22) Filed: Jul. 29, 2002

Related U.S. Application Data
(60) Provisional application No. 60/309,365, filed on Aug. 1, 2001.

(51) Int. Cl. F16J 15/34

(52) U.S. Cl. 277/358

(57) ABSTRACT

A drive mechanism includes a housing, a shaft, and a face seal system. The shaft is mounted within the housing and is capable of being rotatably driven. The face seal system is positioned intermediate the housing and the shaft, the face seal system being configured for promoting at least one of a substantially constant load versus deflection curve and a substantially flat loading curve with respect to wear thereof.

### CONTINUATION DATA

The present application hereby claims the benefit under Title 35, United States Code §119(e) of U.S. provisional application No. 60/309,365 filed Aug. 1, 2001.

### BACKGROUND OF THE INVENTION

1. Field of the Invention

The present invention relates generally to mechanical face seals, and more particularly, to mechanical face seals about small shafts.

2. Description of the Related Art

The prior art reveals mechanical seal designs including the use of elastomers and springs which created a linear spring or loading curves within the sealing systems. Such loading curves caused respective changes in wear-rates such that the internal loading could either rise or fall during seal run-in and wear.

What is needed in the art is a mechanical face seal utilizing a flat or constant load versus deflection or flat loading curves as a seal element wears. In a typical application, face seals may be utilized around shafts in pumps, rotary unions, and other sealing environments.

### SUMMARY OF THE INVENTION

The present invention comprises a mechanical face seal designed for a small shaft, utilizing a combination of a sealing washer or surface with a sealing element biased by either a coil spring or a combination coil spring and energizer, such as an o-ring, to create a substantially flat or constant load curve versus deflection on a seal element. Such constant load on the seal faces of the seal system provides for consistent or constant performance with wear of the face elements. Use of an energizer such as an o-ring provides for static sealing of the assembly. A metallic or composite retaining clip is used for connecting the sealing element, coil spring, and optional o-ring energizer into a unit for ease of assembly. The retaining clip is also connected to or attached to the sealing element to permit controlled drive to the face seal.

In one form of the invention, a thermoplastic sealing element having, in one form, a flat load surface is combined in a sealing assembly with an energizer such as an o-ring, a coil spring, and a retaining clip which holds and contains the seal assembly.

An advantage of the present invention is the mechanical face seal and design thereof, by utilizing a coil spring, during wear and use creates a flat loading curve or constant load versus deflection curve, thereby providing for constant load and consistent performance.

Another advantage is that the o-ring provides static sealing of the assembly.

A further advantage is that the retaining clip permits easy retention to the shaft.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a side sectional view of one form of the present invention;

FIG. 2 is a side sectional view of an alternate embodiment of the present invention;

FIG. 3 is a sectional view of the sealing element of the present invention;

FIG. 4A is a diagrammatic view of an alternate embodiment of the present invention;

FIG. 4B is a diagrammatic view of an alternate embodiment of the present invention;

FIG. 5 is a plan view of the retaining clip of the present invention;

FIG. 6 is a side sectional view of the retaining clip of FIG. 5; and

FIG. 7 is a side view of a number of the components of elements of the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

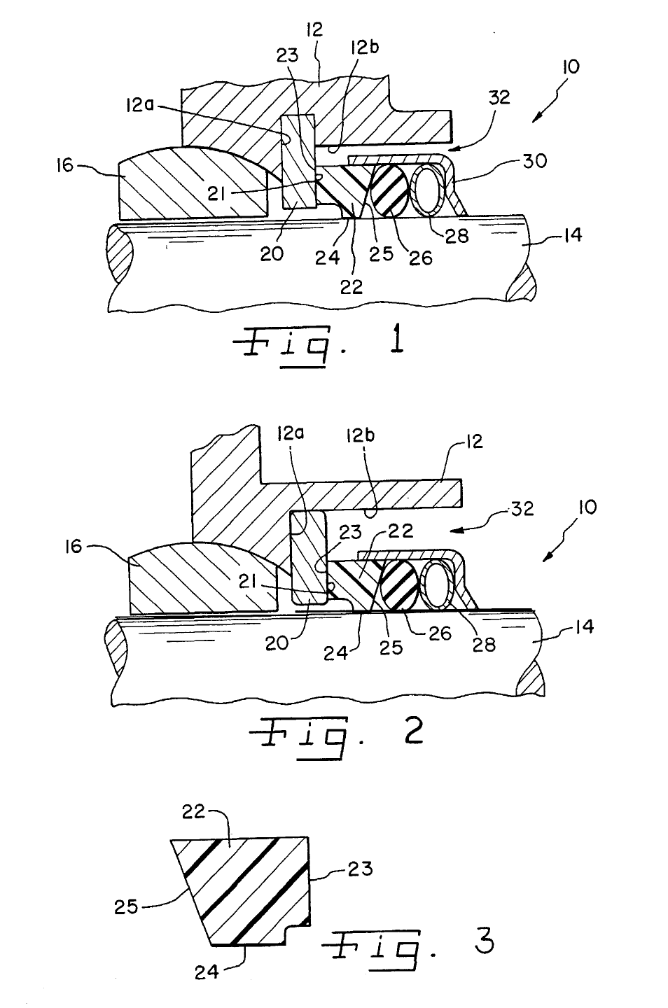

Referring to FIG. 1, the present invention in one form thereof, shows a mechanical face seal 10 in a housing 12 located about a shaft 14. As shown in FIGS. 1 and 2 a bearing 16 is located immediately between the housing 12 and shaft 14 for appropriate location of the shaft to the housing.

The present invention relates to a face seal 10 having a seal washer or face element 20 attached or connected to a first housing surface 12a of housing 12, first housing surface 12a extending substantially orthogonally relative to shaft 14. Housing 12 also includes a second housing face 12b, second housing face 12b extending substantially parallel to shaft 14. Seal washer or face element 20 may be a separate piece or a conjoined or monolithically formed surface of housing 12 and may be formed of metal.

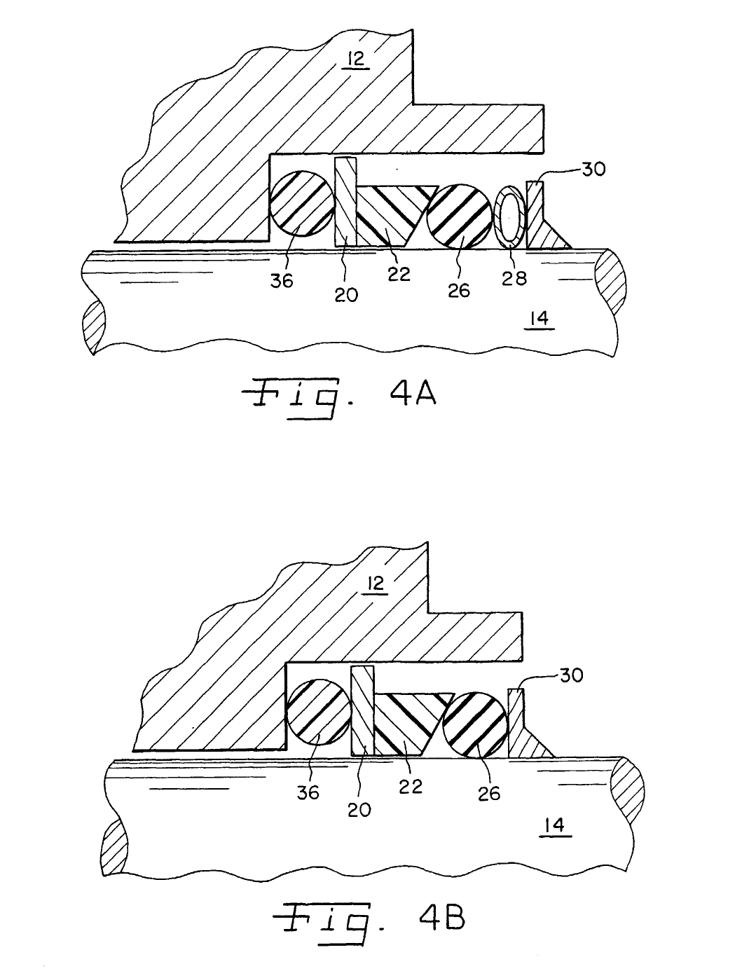

A sealing element 22 (FIGS. 1-3) is advantageously trapezoidal in shape, having a substantially flat sealing surface 23, a shaft-engaging surface 24 which lies opposite shaft 14, and a biasing surface 25 which is angled acutely relative to shaft 14. The flat sealing surface 23 abuts face element 20 or surface 21 thereon and in combination with the forces derived from energizer 26 and coil spring 28, create the performance characteristics of the present invention. Biasing surface 25 of sealing element 22 aids in forcing energizer 26 into contact with shaft 14. Seal element 22 may be made from a conventional sealing material, such as a material chosen from the group including PTFE and other thermoplastics and thermal resins, composites, and alloys.

The energizer 26 adjacent seal element 22 may be made from conventional elastomeric materials. The energizer 26 is useful in creating static sealing of face seal 10.

Coil spring 28, adjacent energizer 26, is useful in the invention, particularly the coil shown in U.S. Pat. No. 5,542,682 and sold under the trademark name of Slantcoil (TM). Use of the coil spring 28 along with the flat sealing surfaces 23 and 24 of sealing element 22 create a flat or constant loading curve between the face seal 10 and the sealing washer 20 or its surface 21.

The face seal system 10 is retained together by a retaining clip 30, as shown in FIGS. 1, 2, 5, and 6. The retaining clip 30 is useful for connecting together mechanical seal 10 along with preventing relative rotation of the elements. Retaining clip or cup 30 may be formed from stainless steel, another type of metal or alloy, or a composite.

Seal washer 20, sealing element 22, energizer/o-ring 26, coil spring 28, and retaining clip 30 are substantially positioned within housing cavity 32, housing cavity 32 being substantially, if not entirely (depending on the embodiment being viewed), defined by first housing surface 12a, second housing surface 12b and shaft 14.

The mechanical face seal 10 is mounted within housing 12 about shaft 14 for only axial movement relative thereto, due at least in part to retaining clip or cup 30. The system 10 may further be constrained from moving radially.

The mechanical face seal 10 is preferably for use in high speed, medium pressure application such as pumps or the like but could be equally well employed in any drive mechanism (e.g., motor or pump) using a rotatably driven shaft.

Alternate conceptional designs of the system are shown in FIGS. 4A and 4B. FIG. 4A shows a seal system 10 in which the seal system includes a separately axially floating seal washer 20 with an interfit elastomer or second elastomer 36. FIG. 4B shows a conceptional view in utilizing two energizers without the use of coil spring 28. The present invention in this form still maintains the flat or constant load versus deflection characteristics.

In some embodiments of use, mechanical face seal 10 may include a separate retainer plate holding the entire assembly in place (not shown).

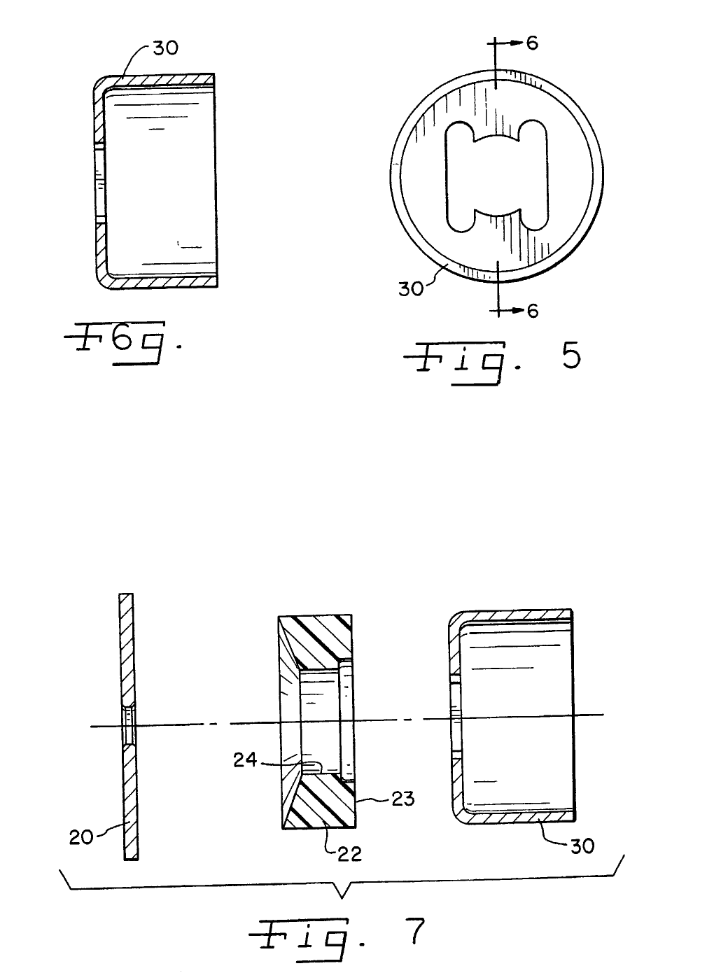

FIGS. 5-7 show different geometries of the seal element 10 parts.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A drive mechanism, comprising:
a housing;
a shaft mounted within said housing, said shaft being capable of being rotatably driven;
a face seal system positioned intermediate said housing and said shaft, said face seal system being configured for promoting at least one of a substantially constant load versus deflection curve and a substantially flat loading curve with respect to wear thereof.

2. The drive mechanism of claim 1, wherein said housing includes a first housing surface and a second housing surface, said first housing surface being substantially orthogonal to said shaft, said second housing surface being substantially orthogonal to said shaft, said first housing surface, said second housing surface and said shaft bounding a housing cavity, said face seal system being located within said housing cavity.

3. The drive mechanism of claim 1, wherein said face seal system includes a seal washer, a sealing element, and at least one of an energizer element and a coil spring.

4. The drive mechanism of claim 3, wherein said housing includes a first housing surface, said first housing surface being substantially orthogonal to said shaft, said seal washer being located proximate said first housing surface, said sealing element abutting both said seal washer and said shaft, said at least one of an energizer element and a coil spring being positioned opposite said seal washer relative to said seal element.

5. The drive mechanism of claim 4, wherein said at least one of an energizer element and a coil spring is configured for biasing said sealing element and said seal washer against one another.

6. The drive mechanism of claim 3, wherein said at least one of an energizer element and a coil spring biases said sealing element and said seal washer against one another.

7. The drive mechanism of claim 3, further including a retaining clip, said retaining clip retaining said seal washer, said sealing element, and said at least one of an energizer element and a coil spring in position relative to one another.

8. The drive mechanism of claim 3, wherein said face seal system includes a first energizer element and a first coil spring, said first energizer element being positioned between said sealing element and said first coil spring.

9. The drive mechanism of claim 8, wherein said first energizer element is configured for statically sealing said face seal system.

10. The drive mechanism of claim 3, wherein said face seal system includes a first energizer element and a second energizer element, said first energizer element being positioned against said sealing element, said second energizer element being positioned against said seal washer.

11. The drive mechanism of claim 10, wherein said face seal system includes a first coil spring, said first energizer element being positioned between said sealing element and said first coil spring.

12. The drive mechanism of claim 1, further including a bearing mounted intermediate said housing and said shaft.

13. A face seal system for facilitating a mounting of a shaft within a housing, said face seal system comprising:
a seal washer;
a sealing element, said sealing element having a first element surface and a second element surface, said first element surface being substantially flat and abutting said seal washer, said second element surface being configured for engaging the shaft; and
at least one of an energizer element and a coil spring, said at least one of an energizer element and a coil spring being positioned opposite said seal washer relative to said sealing element, said at least one of an energizer element and a coil spring biasing said sealing element and said seal washer against one another.

14. The face seal system of claim 13, wherein said face seal system is configured for promoting at least one of a substantially constant load versus deflection curve and a substantially flat loading curve with respect to wear thereof.

15. The face seal system of claim 13, further including a retaining clip, said retaining clip retaining said seal washer, said sealing element, and said at least one of an energizer element and a coil spring in position relative to one another.

16. The face seal system of claim 13, wherein said face seal system includes a first energizer element and a first coil spring, said first energizer element being positioned between said sealing element and said first coil spring.

17. The face seal system of claim 16, wherein said first energizer element is configured for statically sealing said face seal system.

18. The face seal system of claim 13, wherein said face seal system includes a first energizer element and a second energizer element, said first energizer element being positioned against said sealing element, said second energizer element being positioned against said seal washer.

19. The face seal system of claim 18, wherein said face seal system includes a first coil spring, said first energizer element being positioned between said sealing element and said first coil spring.

20. The face seal system of claim 13, wherein said sealing element has a third element surface, said face seal system including a first energizer element, said third element surface contacting said first energizer element, said third element surface being angled in such a manner so as to be configured for biasing said first energizer element toward the shaft.

21. The face seal system of claim 13, wherein said face seal system includes a first energizer element, said first energizer element being an o-ring.
